(19) United States
(12) Patent Application Publication
(10) Pub. No.: US 2017/0320650 A1
(43) Pub. Date: Nov. 9, 2017

(54) COLLAPSIBLE CONTAINER WITH INFLATABLE BLADDER

(71) Applicant: ONLYBOX COMPANY LLC, Buffalo, WY (US)

(72) Inventors: Ian Jacob Aguilar, South Pasadena, CA (US); Michael James Howard, San Francisco, CA (US)

(73) Assignee: ONLYBOX COMPANY LLC, Buffalo, WY (US)

(21) Appl. No.: 15/581,212

(22) Filed: Apr. 28, 2017

Related U.S. Application Data
(60) Provisional application No. 62/333,046, filed on May 6, 2016.

(51) Int. Cl. B65D 81/05; B65D 43/16; B65D 43/22; F16K 27/00

(52) U.S. Cl. CPC B65D 81/052; B65D 43/22; B65D 43/162; F16K 27/00

(57) ABSTRACT

A collapsible container includes an airflow input valve operably connected to one or more bladders on the inside surface of the container via an airflow network.

### CROSS-REFERENCE TO RELATED APPLICATION

This Application claims the benefit of U.S. provisional Application No. 62/333,046, filed on May 6, 2016, in accordance with 35 U.S.C. Section 119(e), and any other applicable laws. The contents of the aforementioned application(s) are hereby incorporated herein by reference in their entirety as if set forth fully herein.

### FIELD OF THE INVENTION

The present invention relates generally to packaging and shipping, and more particularly to a collapsible container used for shipping items without the need for additional packaging material.

### BACKGROUND

Millions of items are shipped worldwide on a daily basis in cardboard boxes. Most of the boxes include some sort of protective packaging material such as STYROFOAM peanuts, bubble wrap, tissue paper, newsprint, airbags, foam wrap, cardboard, and/or shredded paper, to minimize the risk of damage to the items being shipped. Most of the boxes and materials are used only once and then end up in landfills. However, there is a growing desire by individuals and companies alike to reuse and recycle the shipping boxes and associated packaging materials. Effective reusable containers could greatly reduce the need for wood-based corrugated packaging material produced through the destruction of trees and habitats, and also the less degradable dunnage materials such as plastics and STYROFOAM.

Therefore, a need exists for a reusable and/or recyclable container that can be used in place of cardboard shipping boxes, and without the need for additional packaging material.

### SUMMARY

The present invention comprises a collapsible container used for shipping items. The container may also be reusable and/or recyclable, and may be made of various suitable materials to ensure the proper amount of durability and flexibility. The container includes an internal bladder that may be inflated to desired dimensions to protect the items during transport, in place of typical packaging material. The bladder may be deflated thereafter to collapse the container for efficient storage, and/or for return shipping to a shipping center or the like for reuse. The bladder is inflated/deflated via one or more airflow valves or nozzles attached to the container.

### DRAWINGS

FIG. 1 is a perspective view of a collapsible container in accordance with embodiments of the present invention, in a collapsed configuration.

FIG. 2 is a perspective view of the collapsible container of FIG. 1, in an expanded configuration, with an open top, showing a typical airflow network in accordance with embodiments of the present invention.

FIG. 3 is a perspective view of the collapsible container of FIG. 2, showing a typical bladder system in accordance with the present invention.

FIG. 4 is a perspective view of the collapsible container of FIG. 3, showing items placed therein.

FIG. 5 is a perspective view of the collapsible container of FIG. 4, with the top closed and the sealing device implemented.

FIG. 6 is a cross-sectional view of the collapsible container of FIG. 5, along the line 6,7-6,7.

FIG. 7 is a cross-sectional view of the collapsible container of FIG. 5, along the line 6,7-6,7, but with the bladder system inflated.

### DETAILED DESCRIPTION

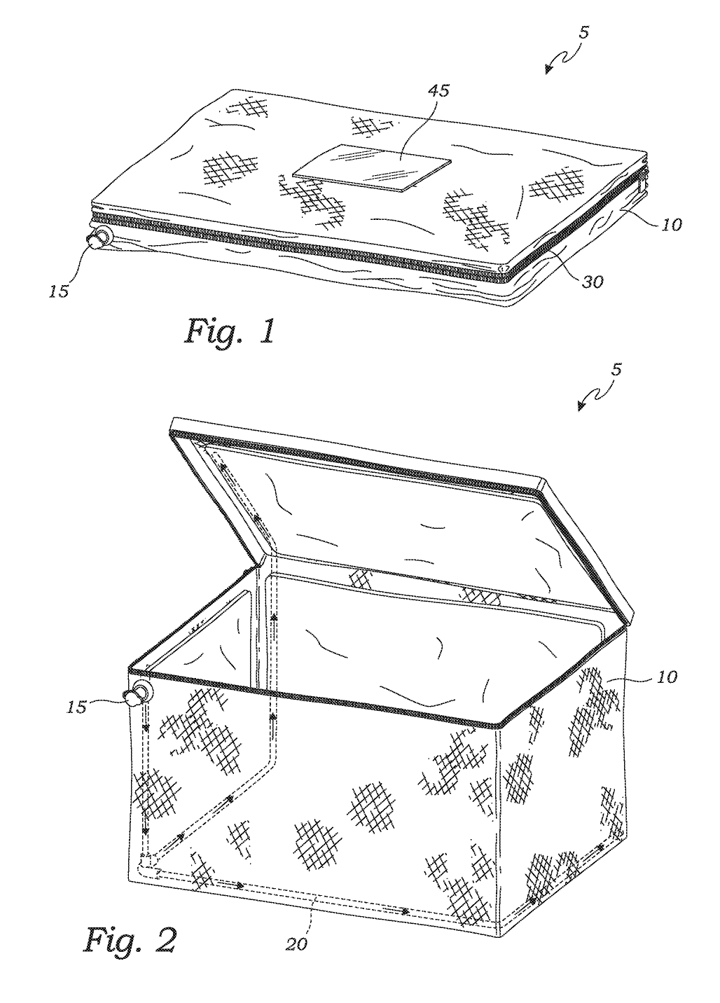

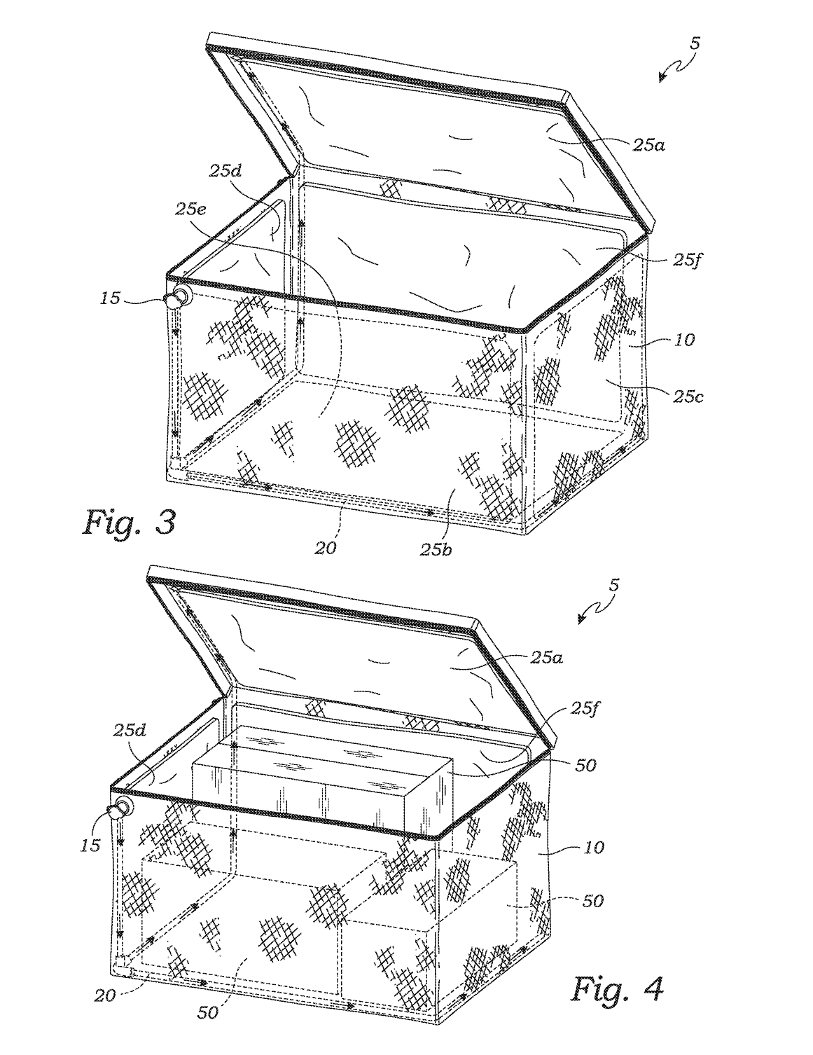

The present invention comprises a collapsible container used for shipping items, and methods of use of the container. FIG. 1 shows a container 5 in accordance with an embodiment of the present invention, in a collapsed configuration. FIGS. 2 and 3 show the same container 5 in an expanded configuration. The container 5 comprises a body 10, an air valve 15, an air-flow network 20, a bladder system 25, and a sealing device 30.

The body 10 may be made of various suitable materials to ensure the proper amount of durability and flexibility. For example, the body 10 should be able to withstand a suitable amount of surface contact and friction as would be expected for any package 50 in transit through the USPS or other courier service. Such materials include hemp, cotton, and/or denim. These materials are easily renewable, durable, and flexible. Typically, the body 10 is fabricated by sewing or stitching a desired pattern, such as a six-sided box. The body 10 is not very rigid, but receives sufficient structural support as further described herein. A shipping label sleeve 45 may be included on the outer surface of the body 10.

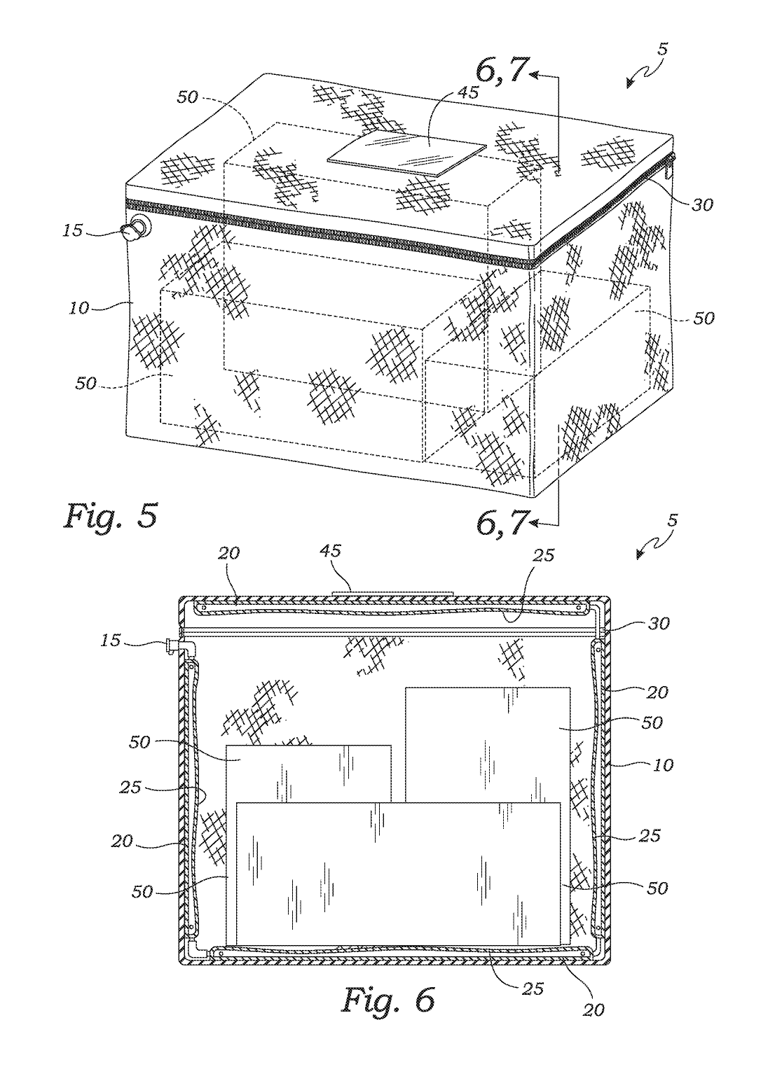

The interior of the container 5 includes an airflow network 20, as best seen in FIG. 2. The airflow network 20 typically includes plastic and/or rubber tubing, has an entry point in direct fluid (e.g. air) communication with an airflow valve 15, and an exit point in direct fluid (e.g., air) communication with a bladder system 25, all as further described herein. The flexibility of the tubes may vary from very rigid, to semi-rigid, to non-rigid, but typically the tubes should be rigid enough to provide a level of impact and structural support to the container 5 when the container 5 is in an expanded configuration as seen in FIGS. 2-7. Accordingly, the tubes may be cylindrical or any other suitable shape. For example, the tubes may be prisms with triangular, rectangular, octagonal, or other lateral cross-sections. The tubes may coincide with each internal edge of the container 5, or only selected edges as seen, e.g., in FIG. 2. The tubes may be sewn, glued, loose, or otherwise attached and organized as to be unobstructive to the interior function of the inflated bladder and cargo space. In any case, each bladder 25 should be in fluid communication with at least one tube.

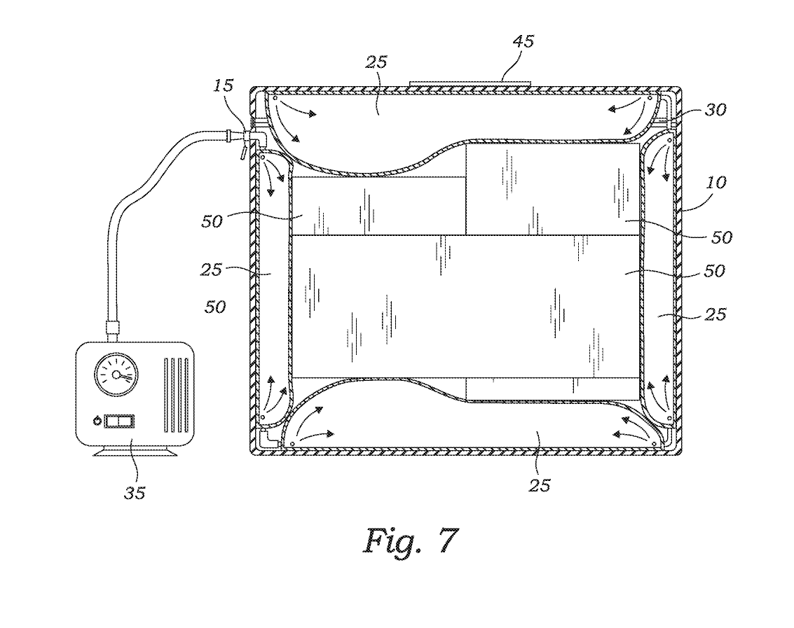

The interior of the container 5 includes a bladder system 25. The bladder system 25 may include a single bladder, or multiple bladders, e.g., 25a-25f on the inside surface of each face of the container 5, as seen in FIG. 3. The bladder system 25 is inflated to desired dimensions to protect the items during transport, as seen in FIG. 7 where packages 50 are squished closer together than before inflation. In other words, the bladders 25 are typically inflated to a degree to ensure an appropriate fit without the necessity of additional dunnage such as STYROFOAM peanuts or the like. The degree of inflation may be controlled manually and/or by mechanical means such as by a suitable compressor 35 with an automatic pressure-based shutoff feature. The bladders 25 are deflated once the shipping is complete, to collapse the container 5 for efficient storage, and/or for return shipping to a shipping center or the like for reuse, as seen in FIG. 1. The bladders 25 may be made of inflatable plastic, rubber, and/or other suitable materials, preferably organic and/or recyclable. The bladders 25 are in fluid communication with each other via the airflow network 20. The bladders 25 also help create shape definition to the container, and may help provide rigidity at the edges of the container 5 due to seams. Bladders 25 may be sewn in, glued, separate/detached from the body, 10, or otherwise attached so as to provide rigidity around the usual defined edges of a box. When deflated, the container 5 is again collapsed and malleable. In the collapsed configuration, the container 5 may be foldable and/or rollable to minimize its profile for efficient storage and/or return to the shipper or refurbishing facility. Strings, snaps, straps, buttons, wraps, ties, sleeves, and/or other devices may be used to secure and enforce the collapsed container shape.

The container also includes a valve or nozzle 15 to allow inflation (and deflation) of the bladders 25. The valve 15 may be made from natural or synthetic rubber, polyurethane, PVC, or other suitable material, depending on durability, reusability, and recyclability requirements. Typically, the valve 15 will be on an inside surface of the container 5, so that upon closing of the container 5, the valve 15 is not exposed. Whether on the inside or outside, the valve 15 is typically retractable into a recess, as is known in the art.

The valve 15 may be configured for attachment to an external air compressor 35, so inflation is performed by activating the compressor 35. The valve 15 may include hard metals, hard rubber, soft rubber, and/or plastics, and is preferably inward facing relative to container 5 to protect against damage due to exposure to external forces and conditions. The bladders 25 are all connected via the airflow network 20 such that upon activation of a compressor 35 (or other air supply source) operably connected to the valve 15, air from the air supply source flows through the valve 15 to the entry point of the air flow network 20, through the air flow network 20, out the exit point of the air flow network 20, to bladders 25, such that all of the bladders 25 inflate substantially simultaneously. Inflating the bladders 25 substantially simultaneously includes, for example, situations in which the various bladders 25 receive air at slightly different times due to the length of the air path from the exit point (or points as described below) to the individual bladders.

The airflow network 20 may have multiple entry points and/or exit points. With multiple exit points, e.g., one corresponding to each of a plurality of bladders 25, the bladders 25 may be inflated/deflated individually if so desired. The valve 15 may have a pull tab 40, screw, or be otherwise configured for efficient deflation, and may be one-way or two-way. There may be more than one valve 15.

The container 5 also includes a sealing device/mechanism 30, used to seal the container 5 before shipping, and to unseal the container 5 to unpack its contents upon receipt. The sealing device 30 may be a zipper, snap, zip-tie, VELCRO, or other suitable structure, or any combination thereof, sufficient to secure the container 5 closed prior to shipping.

In practice, shipping centers will typically maintain an inventory of various target-sized and target-shaped containers, e.g., different SKU numbers or models, and will offer an option for consumers to receive their items in such containers. The containers may be branded for a particular shipper, retailer, etc., and/or may include advertising from third parties. Once the shipper decides to use the container, either independently, by request of the consumer, or otherwise, the shipper identifies the specific model container to fit the needs of the specific shipment. Presuming the containers are stored in a collapsed configuration, the shipper then expands or unfolds the container, places the items to be shipped inside, inflates the bladders via the valve(s) using an air supply source such as a compressor, closes the container, secures the open top of the container, inserts any shipping label or other markings on the container (including, e.g., a package or seal number, advertising, etc.), then sends the container off for shipment.

From the recipient's perspective (e.g., an on-line e-commerce consumer), once the container is received, the recipient confirms the seal number, cuts the seal, opens the container, removes the item(s), deflates the bladder(s) by opening the valve(s), collapses the container, then places the container in the outbound mail for delivery back to the shipper, or delivers to a logistics store (such as The UPS Store) for consolidation with other similar containers that can then be returned to the shipper via bulk ground freight rather than individual mailing.

When the shipper receives an empty container by return mail, the container may be inspected then returned back into inventory for reuse, or sent for refurbishment or recycling as the case may be. This may be done manually, or by scanning, or other automated process. Receipt of an empty container by the shipper may trigger a text, email and/or other notifications to the consumer and/or retailer (e.g., if the retailer is different than the shipper). The notice to the consumer may include recognition of the consumer's participation in eco-friendly commerce, by way of a thank you message, and/or credit or discount off of the consumer's next purchase. The notice to a retailer may be similar, and may include the consumer information to allow the retailer to directly offer discounts or other incentives to the consumer for the consumer's participation in eco-friendly commerce. If the container is not returned in a stated time frame, e.g., 30 days, the consumer may instead be charged a fee to cover the cost of the container.

With the present invention, waste is reduced, and shipping containers are reused and/or recycled. This satisfies a growing desire by individuals and companies to be a part of an eco-friendly society. Also, although the initial investment in a container described herein will likely outweigh the cost of an individual cardboard box or similar shipping container (including any plastic/STYROFOAM dunnage), repeated use of the container will create savings and eventually drop cost per use, creating a positive financial return on investment for the shipper.

Although particular embodiments of the present inventions have been shown and described, it will be understood that it is not intended to limit the present inventions to the preferred embodiments, and it will be clear to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A collapsible container comprising:
a collapsible body, an airflow valve, an airflow network, a bladder system, and a sealing device;
wherein the airflow network is attached to an inside surface of the body, and comprises an entry point in direct fluid communication with the airflow valve, and an exit point in direct fluid communication with the bladder system;
wherein the airflow valve is configured to receive incoming air from an air source such that the incoming air flows from the air source through the airflow valve, to the entry point of the airflow network, through the airflow network, out the exit point of the airflow network, to the bladder system, such that the bladder system thereby inflates; and
wherein the sealing device is configured to seal the container.

2. The collapsible container of claim 1, wherein the sealing device is a zipper.

3. The collapsible container of claim 1, wherein the airflow network is sewn into the inside surface of the body.

4. The collapsible container of claim 1, wherein the airflow valve is attached to the inside surface of the body.

5. The collapsible container of claim 1, configured to expand into a rectangular box-shaped container, and wherein the bladder system comprises six separate bladders, one on each of six inner surfaces of the inside surface of the body.

6. The collapsible container of claim 5, wherein the airflow network comprises six exit points, each in direct fluid communication with a corresponding one of the six bladder
